(19) United States
(12) Patent Application Publication
(10) Pub. No.: US 2026/0266262 A1
(43) Pub. Date: Sep. 10, 2026

(54) TRANSPORT SYSTEM FOR A ROTOR BLADE OF A WIND TURBINE

(71) Applicant: Nordex Energy Spain S.A.U., Barásoain (Navarra) (ES)

(72) Inventors: Iñaki Bidegain Ameztoy, Sarriguren (ES); Unai Arraztoa Magaña, Irurita (ES); Rajesh Rajendiran, Chennai (IN); Christopher Naveen Irudayaraj, Chennai (IN); Govarthanan Venkatesan, Minjur (IN)

(21) Appl. No.: 19/165,025

(22) PCT Filed: Mar. 12, 2024
(86) PCT No.: PCT/EP2024/056526

§ 371 Date: Sep. 12, 2025

(30) Foreign Application Priority Data
Mar. 14, 2023 (BR) 1020230047203

(51) Int. Cl. F03D 13/40; B60P 3/40

(52) U.S. Cl. CPC F03D 13/401; B60P 3/40; F05B 2260/02

(57) ABSTRACT

According to an embodiment, the transport system includes a root support element which is configured to be connected to the root end of a rotor blade. Furthermore, the transport system includes a clamping element which is configured to clamp a section of the rotor blade distant from the root end. The transport system enables the transport of a rotor blade for a wind turbine with the pressure side of the rotor blade up when the root end of the rotor blade is connected to the root support element and when the section of the rotor blade is clamped in the clamping element.

### CROSS-REFERENCE TO RELATED APPLICATIONS

This application is a continuation application of international patent application PCT/EP 2024/056526, filed Mar. 12, 2024, which designates the United States and claims priority from Brazilian patent application 1020230047203 filed Mar. 14, 2023. The present continuation application claims priority to each of the above applications and incorporates herein the entire contents thereof by reference.

### TECHNICAL FIELD

The present disclosure relates to a transport system for a rotor blade of a wind turbine. Furthermore, the present disclosure relates to a transport arrangement with a rotor blade and with such a transport system, to a vehicle with such a transport arrangement, to a method for building such a transport arrangement and to a use of the transport system for transporting a rotor blade.

### BACKGROUND

Wind turbines are widely known and are used to convert wind energy into electrical energy. The lengths of the rotor blades used in such wind turbines have increased in recent years. Accordingly, the transport of these rotor blades is a challenge.

### SUMMARY

One object to be achieved is to provide an improved transport system for a rotor blade, particularly a transport system which enables a safe land transport of a rotor blade. Further objects to be achieved are to provide a transport arrangement with a rotor blade and with such a transport system, a vehicle with such a transport arrangement, a method for building such a transport arrangement and a use of the transport system for transporting a rotor blade.

First, a transport system is specified.

According to an embodiment, the transport system includes a root support element which is configured to be connected to the root end of a rotor blade.

Furthermore, the transport system includes a clamping element which is configured to clamp a section of the rotor blade distant from the root end. The transport system enables the transport of a rotor blade for a wind turbine with the pressure side of the rotor blade up when the root end of the rotor blade is connected to the root support element and when the section of the rotor blade is clamped in the clamping element.

The transport of a rotor blade, particularly when transported by road, can cause safety problems. For example, when the rotor blade is transported with its pressure side down, the tip of the rotor blade may be too close to the ground and may cause an accident. Moreover, the trailing edge of the rotor blade may then protrude more than the leading edge on the truck driver's side and on the inner side of the lane on a two-lane road. As a result, the rotor blade may obstruct the truck driver's view with respect to overtaking traffic. The rotor blade may cause an accident if the blade protrudes into the oncoming traffic when the division line is crossed.

The inventors of the present invention had the idea that these problems can be avoided by transporting the rotor blade with the pressure side up.

The root support element may be, for example, a root transport frame with a support surface onto which the root end of the rotor blade can be laid. The root support element may include a plurality of connection means provided for connecting the root support element with the root end of the rotor blade. The connection means are, for example, holes or drillings, through which bolts of the rotor blade can be guided.

When the root end of the rotor blade is connected to the root support element, the rotor blade may exceed the root support element in vertical direction. Particularly, the height of the root support element is smaller than the diameter of the root end of the rotor blade which can be transported with the root support element. Fox example, the height is at most half of the diameter.

The clamping element may include two parts which are hingeably and/or pivotably connected to each other. The clamping element is, for example, configured to be opened in order to enable the insertion of a rotor blade and may be configured to be closed in order to secure the rotor blade. For example, an upper part of the clamping element can be lifted with respect to a lower part of the clamping element in order to open the clamping element and can then be let down again with respect to the lower part in order to close the clamping element. The clamping element may be configured such that the closed configuration can be secured, for example, by using bolts or screws.

The clamping element is configured to clamp a section of the rotor blade which is distant from the root end. For example, the section is closer to the tip end than to the root end of the rotor blade. For example, the clamping element is configured to clamp a section of the rotor blade which is at least half or at least ⅔ of the length of the rotor blade away from the root end.

The transport system is configured to enable the transport of the rotor blade with the pressure side up, that is, such that the pressure side faces upwards. This means, in particular, that the root support element and the clamping element are formed such that they are able to reliably support and reliably secure the rotor blade for its transport with the pressure side up. For example, when the root end is connected to the root support element and supported thereby and the tip end is clamped in the clamping element, transport of the rotor blade with the pressure side up without slippage of the rotor blade relative to the clamping element and the root support element and/or without extensive vibration of the rotor blade and/or without contact of the rotor blade to the ground is enabled.

The terms “up”, “upwards”, “down” and “downwards” are herein used with respect to the direction of gravity. Particularly, “up” and “upwards” are directions away from the ground or from the road and “down” or “downwards” are directions facing the ground or the road, respectively.

The transport system described herein is a modular system. The root support element and the clamping element are modules or components, respectively, of the transport system which can be handled separately from each other.

According to a further embodiment, the transport system is additionally configured to enable the transport of the rotor blade with its pressure side down.

For example, the root support element and the clamping element are both configured to reliably support and secure the rotor blade for its transport with the pressure side up as well as for its transport with the pressure side down. Alternatively, the transport system may include a further root support element which is configured for the transport with the pressure side down.

According to a further embodiment, the clamping element is configured to be used in two different orientations, namely a first orientation for the transport of the rotor blade with its pressure side up and a second orientation for the transport of the rotor blade with its pressure side down. That is, the clamping element is configured such that it can be used for both the transport with the pressure side up and the transport with the pressure side down.

According to a further embodiment, the clamping element is rotated around a vertical axis in the second orientation compared to the first orientation. Particularly, when the transport system is used for transporting the rotor blade with its pressure side up, a side of the clamping element faces towards the root end of the rotor blade. When the transport system is used for transporting the rotor blade with its pressure side down, this side of the clamping element faces away from the root end of the rotor blade. In other words, when changing from transport with the pressure side up to transport with the pressure side down or vice versa, the clamping element only has to be rotated around a vertical axis. The amount of rotation necessary for changing from the first to the second orientation, or vice versa, is, for example, 180°±10°. The vertical axis is herein an axis parallel to the direction of gravity.

By way of example, the clamping element has an asymmetric configuration with respect to a plane running parallel to the vertical axis and through the clamping element. When the section of the rotor blade is clamped in the clamping element, this plane may run parallel or essentially parallel to the main extension direction (longitudinal axis) of the rotor blade.

According to a further embodiment, the transport system further includes a packing, herein also referred to as “first packing”. The packing has an upper and a lower surface. The upper surface is configured to adjoin the pressure side of the rotor blade and the lower surface is configured to adjoin the suction side of the rotor blade.

According to a further embodiment, the transport system further includes a further packing, herein also referred to as “second packing”. The further packing has an upper and a lower surface. The upper surface is configured to adjoin the suction side of the rotor blade and the lower surface is configured to adjoin the pressure side of the rotor blade.

The transport system may either include only the first packing or it may include both the first and the second packing. All features disclosed herein for the first packing are disclosed for both cases, namely the case that the transport system includes the first and the second packing and the case that the transport system only includes the first packing.

A packing is herein understood as a component of the transport system which is configured to receive the section of the rotor blade clamped in the clamping element.

The packing, or at least the upper and the lower surface thereof, may be formed of a plastic and/or a soft material in order to avoid damage to the rotor blade. For example, the material of the upper and the lower surface is a rubber, like EPDM (ethylene propylene diene monomer). The packing(s) is(are) formed, for example, such that the upper and the lower surface conformally or formfittingly, respectively, adjoin the section of the rotor blade.

The upper surface of a packing is herein defined as the surface facing downwards and adjoining the rotor blade during transportation and the lower surface of the packing is herein defined as the surface facing upwards and adjoining the rotor blade during transportation.

The upper surface of the first packing reshapes, for example, the pressure side of the to-be-transported rotor blade in the area of the section to be clamped in the clamping element. The lower surface of the first packing may reshape the suction side of the-to-be transported rotor blade in the area of the section to be clamped in the clamping element.

Likewise, the upper surface of the second packing may reshape the suction side of the to-be-transported rotor blade in the area of the section to be clamped in the clamping element and the lower surface of the second packing may reshape the pressure side of the to-be-transported rotor blade in the area of the section to be clamped in the clamping element.

The upper surface of a packing may be formed by an upper panel or mold of the respective packing and the lower surface of the packing may be formed by a lower panel or mold of the respective packing. The upper and the lower panels/molds may be separate elements.

According to a further embodiment, the first and the second packing are both reversibly attachable to the clamping element so that, depending on whether the rotor blade is to be transported with its pressure side up or its pressure side down, either the first or the second packing can be used for the transportation. Particularly, the upper panel/mold of each packing may be reversibly attachable to the upper part of the clamping element and the lower panel/mold of each packing may be reversibly attachable to the lower part of the clamping element.

In the case that the transport system is only configured for the transport of a rotor blade with the pressure side up, the first packing may alternatively be permanently attached or fixed to the clamping element. In this case the transport system does not include the second packing.

According to a further embodiment, the transport system includes a further root support element. The transport system enables the transport of the rotor blade with its pressure side down when the root end of the rotor blade is connected to the further root support element and when the section of the rotor blade is clamped in the clamping element.

In other words, usage of the root support element, herein also referred to as “first root support element”, together with the clamping element enables the transport of the rotor blade with its pressure side up. The usage of the further root support element, herein also referred to as “second root support element”, together with the clamping element enables the transport of the rotor blade with its pressure side down.

Particularly, the first root support element together with the clamping element in its first orientation and together with the first packing enables the transport with the pressure side up and the second root support element together with the clamping element in its second orientation and together with the second packing enables the transport with the pressure side down.

The transport system may either include only the first root support or it may include both the first and the second root support element. All features disclosed herein for the first root support element are disclosed for both cases, namely the case that the transport system includes the first and the second root support element and the case that the transport system only includes the first root support element.

The first root support element and the second root support element are, in particular, structurally different. For example, the first root support element and the second root support element have different heights and/or widths and/or support surfaces. For example, the second root support element has a greater width than the diameter of the root end of the rotor blade which can be transported with the second root support element.

According to a further embodiment, the root support element and the further root support element both include a support surface configured to adjoin and to support the root end of the rotor blade. The support surface is, in particular, configured to conformally or formfittingly, respectively, adjoin the root end. In other words, the support surface may be formed to reshape at least a section of the root end of the rotor blade which can be transported with the help of the root support element.

According to at least one embodiment, the support surfaces are both concavely formed. The support surfaces may both have the shape of a sector of a cylinder surface. When transporting the rotor blade, the support surfaces of the root support elements may face upwards.

According to a further embodiment, the support surfaces are both asymmetric with respect to the respective deepest point of the support surface such that the sections of the support surfaces on both sides of the respective deepest point have different lengths.

In other words, the first root support element has a support surface which has a deepest point, that is, a point being closest to the ground during transport of the rotor blade. The sections of the support surface on both sides (for example, left and right with respect to the length axis of the rotor blade) of this deepest point are formed differently, particularly with different lengths. The lengths are hereby meant to be the lengths in circumferential direction, for example. Particularly, when the root end of the rotor blade lies on the support surface and is supported thereby, the contact areas on both sides of the deepest point are different.

The same as disclosed in the last paragraph with respect to the first root support element is accordingly also disclosed for the second root support element in the case that the transport system includes such a second root support element.

The above-mentioned circumferential direction is, in particular, a direction around the length axis of the rotor blade when connected to the root support element.

According to a further embodiment, the relative arrangement of the longer and the shorter section of the support surface of the (first) root support element is inverse to the relative arrangement of the longer and the shorter section of the support surface of the further/second root support element. For example, when a rotor blade is transported with its pressure side up with the help of the transport system and, for this purpose, the first root support element is connected with the root end of the rotor blade, the longer section of the support surface of the first root support element is left and the shorter section is right, when viewed along a certain direction which is parallel to the longitudinal axis of the rotor blade. When the rotor blade is transported with its pressure side down with the help of the transport system and, for this purpose, the second root support element is connected with the root end of the rotor blade, the longer section of the support surface of the second root support element is right and the shorter section is left, when viewed along the same certain direction.

According to a further embodiment, the transport system further includes a tip transport frame. The tip transport frame is configured to receive and/or support the clamping element and to be connected with the clamping element. For example, the tip transport frame surrounds the clamping element received therein. The tip transport frame may be configured such that the gravitational load of the rotor blade, acting on the clamping element when the rotor blade is clamped by the clamping element, is diverted downwards via the tip transport frame. The height on which the section of the rotor blade is clamped in the clamping element and supported may be adjusted with the help of the tip transport frame. The clamping element may be reversibly connectable to the tip transport frame.

According to a further embodiment, the clamping element is rotated relative to the tip transport frame around the vertical axis in its second orientation compared to its first orientation. Particularly, the tip transport frame is configured to be used for the transport of the rotor blade with the pressure side up as well as for the transport with the pressure side down. Changing from a configuration enabling transport with the pressure side up to a configuration enabling transport with the pressure side down may then require a rotation of the clamping element around the vertical axis with respect to the tip transport frame. The rotation is, for example, a rotation by 180°±10°.

Additionally or alternatively, the relative orientation between the tip transport frame and the respective root support element during transport of the rotor blade with the pressure side up is the same as during transport of the rotor blade with the pressure side down.

Next, the transport arrangement is specified. Since the transport arrangement includes the transport system described herein, all features disclosed herein for the transport system are also disclosed for the transport arrangement and vice versa.

According to an embodiment, the transport arrangement includes a rotor blade and a transport system according to any of the embodiments described herein. The root end of the rotor blade is thereby connected to the root support element and is thereby supported. A section of the rotor blade is clamped in the clamping element. The rotor blade is orientated with its pressure side up. In this embodiment, the clamping element may be in its first orientation.

According to an alternative embodiment, the transport arrangement includes a rotor blade and a transport system according to any of the embodiments described herein. The root end of the rotor blade is thereby connected to the further root support element and is supported thereby. A section of the rotor blade is clamped in the clamping element. The rotor blade is orientated with its pressure side down. In this embodiment, the clamping element may be in its second orientation.

According to a further embodiment, the first packing is attached to the clamping element. This is particularly the case when the rotor blade is orientated with its pressure side up. The upper and the lower surface of the first packing may adjoin the pressure side and the suction side of the rotor blade. Particularly, the upper and lower surfaces of the packing may adjoin the rotor blade at its pressure side and its suction side in a conformal manner or formfitting manner, respectively.

According to a further embodiment, the second packing is attached to the clamping element. This is, in particular, the case when the rotor blade is orientated with its pressure side down. The upper and the lower surface of the second packing may adjoin the suction side and the pressure side of the rotor blade. Particularly, the upper and lower surfaces of the second packing may adjoin the rotor blade at its suction side and its pressure side in a conformal manner or formfitting manner, respectively.

According to a further embodiment, the root end of the rotor blade adjoins the support surface of the first root support element and is supported thereby. The center of gravity of the rotor blade is, for example, arranged on the same side as the longer section of the support surface.

On the same side herein means, in particular, that when viewed in a certain direction parallel to the length axis of the rotor blade, the center of gravity of the rotor blade and the longer section of the support surface are on the same side of a straight line extending in vertical direction and through the deepest point of the support surface.

According to a further embodiment, the root end of the rotor blade adjoins the support surface of the second root support element and is supported thereby. The center of gravity of the rotor blade is, for example, arranged on the same side as the longer section of the support surface.

Next, the vehicle is specified.

According to an embodiment, the vehicle includes the transport arrangement according to any of the embodiments described herein. The vehicle is configured to transport the rotor blade from one location to another.

Since the vehicle includes the transport arrangement as specified herein, all features disclosed for the transport arrangement are also disclosed for the vehicle and vice versa. The vehicle is, for example, a truck or a train or a dolly. The transport arrangement may be loaded onto a loading area of the vehicle.

Next, the method for building a transport arrangement is specified. The method may be used to build any one of the transport arrangements as specified herein.

Therefore, all features disclosed in connection with the transport arrangement are also disclosed for the method and vice versa.

According to an embodiment, the method includes providing the transport system according to any one of the embodiments described herein and providing a rotor blade for a wind turbine. The root end of the rotor blade being orientated with its pressure side up is connected to the first root support element. Furthermore, a section of the rotor blade being orientated with its pressure side up is clamped into the clamping element.

According to an alternative embodiment, the method includes providing the transport system according to any one of the embodiments described herein and providing a rotor blade for a wind turbine. The root end of the rotor blade being orientated with its pressure side down is connected to the second root support element. Furthermore, a section of the rotor blade being orientated with its pressure side down is clamped into the clamping element.

By way of example, the method for building a transport arrangement is as follows: It is decided whether a rotor blade for a wind turbine shall be transported with the pressure side up or the pressure side down.

In the case that it is decided to transport the rotor blade with its pressure side up, the first root support element is used together with the clamping element, the first packing and optionally the tip transport frame. If not already attached to the clamping element, the first packing is attached to the clamping element. If not already attached to the tip transport frame in its first orientation, the clamping element is attached to the tip transport frame in its first orientation. Then, the rotor blade orientated with the pressure side up is connected to the first root support element and a section of the rotor blade orientated with the pressure side up is clamped into the clamping element so that the upper and lower surfaces of the first packing adjoin the pressure side and the suction side, respectively.

If, on the other hand, it is decided that the rotor blade shall be transported with the pressure side down, the second root support element is used together with the clamping element, the second packing and optionally the tip transport frame. If not already attached to the clamping element, the second packing is attached to the clamping element. If not already attached to the tip transport frame in its second orientation, the clamping element is attached to the tip transport frame in its second orientation. Then, the rotor blade orientated with its pressure side down is connected to the second root support element and a section of the rotor blade orientated with the pressure side down is clamped into the clamping element so that the upper and the lower surfaces of the second packing adjoin the suction side and the pressure side, respectively.

For connecting the rotor blade to the root support element and the clamping element, first the root support element may be connected with the root end since this gives the exact turn of the blade so that it fits well into the packing.

For example, the transport system is used to transport the rotor blade on land and sea. For transport on land, the rotor blade is transported with the pressure side up and, accordingly, the transport arrangement is built up as described before. For transport on sea, the rotor blade is transported with the pressure side down and, accordingly, the transport arrangement is built up as described before.

Next, a use of the transport system is specified.

According to an embodiment, the transport system according to any one of the embodiments described herein is used for transporting a rotor blade from one location to another location with the pressure side of the rotor blade up. For example, the transport may be realized with the transport arrangement described herein.

The transport system may first be used for transport on land and then for transport on sea or vice versa. Accordingly, the arrangement may have to be built up in different configurations as described before.

### BRIEF DESCRIPTION OF DRAWINGS The invention will now be described with reference to the drawings wherein:

FIG. 1 shows an embodiment of the vehicle;

FIG. 2 shows an embodiment of the transport arrangement and of the transport system;

FIGS. 3 to 7 show different components of an embodiment of the transport system; and,

FIGS. 8 and 9 show flowcharts of embodiments of the method for building a transport arrangement.

### DETAILED DESCRIPTION

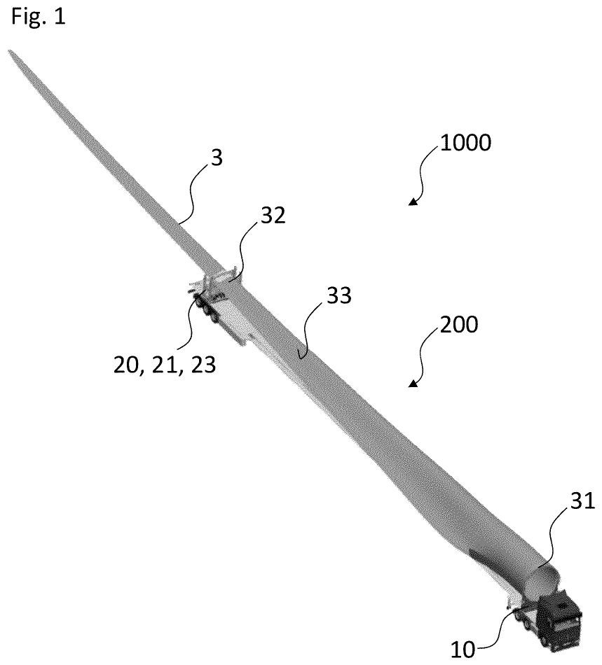

FIG. 1 shows an embodiment of the vehicle 1000. The vehicle 1000 is a truck. A transport arrangement 200 is loaded onto a loading area of the truck. The transport arrangement 200 includes a rotor blade 3 for a wind turbine supported by a root support element 10 and a tip support structure 20, 21, 23. The root support element 10 and the tip support structure 20, 21, 23 are components of an embodiment of the transport system. The rotor blade 3 is supported and transported with its pressure side 33 up. This is beneficial as it prevents the tip end of the rotor blade 3 from coming too close to the road and prevents the truck driver's view from being obstructed by the tip end of the rotor blade 3.

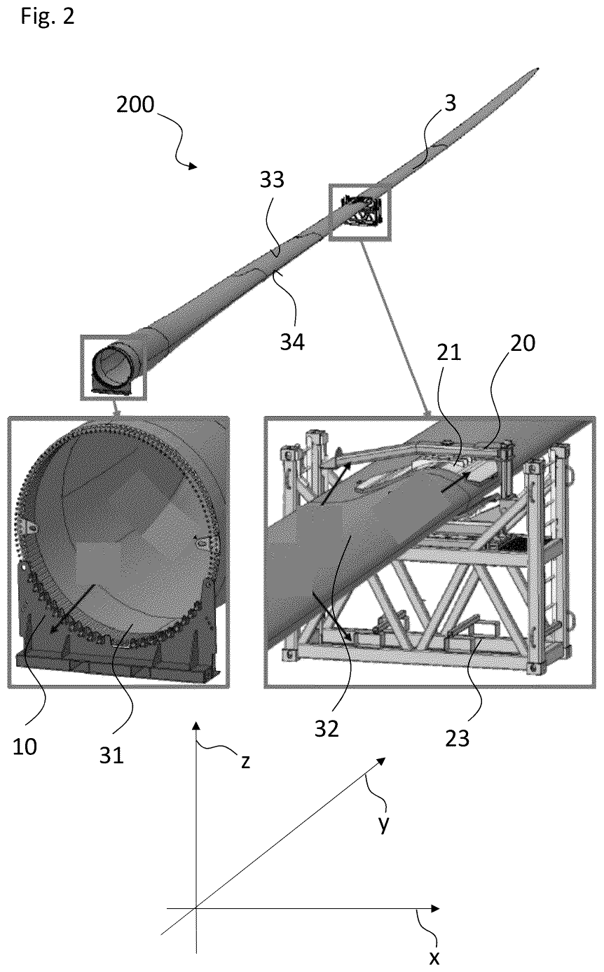

FIG. 2 shows the transport arrangement 200 of FIG. 1 in greater detail. Here, the transport arrangement 200 is not (yet) loaded onto the loading area of a vehicle. FIG. 2 also indicates a coordinate system which is used consistently in this and the following figures.

In the transport arrangement 200, the root end 31 of the rotor blade 3 is connected to a root support element 10, herein also called first root support element 10. This first root support element 10 is configured to securely support the root end 31 of the rotor blade when the rotor blade 3 is orientated with its pressure side 33 up.

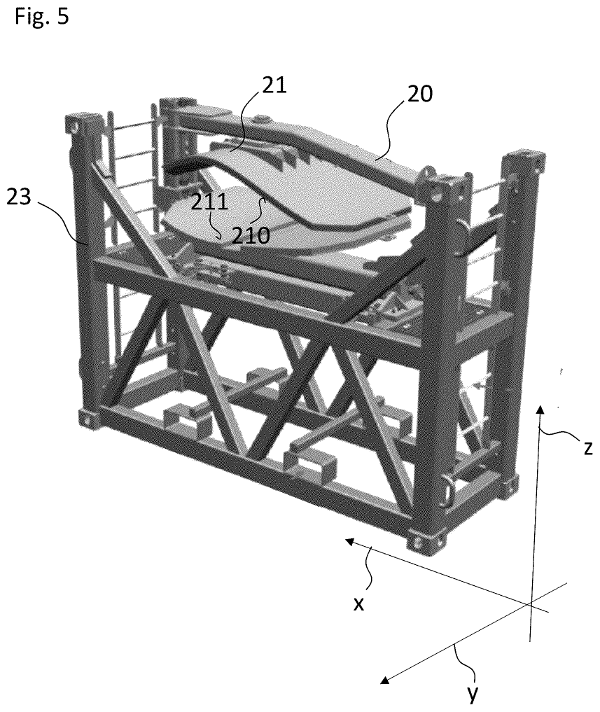

Furthermore, in the transport arrangement 200, a section 32 of the rotor blade 3 distant from the root end 31 is supported by the support structure 20, 21, 23. The support structure includes a tip transport frame 23, a clamping element 20 and a packing 21. The packing 21, herein also called first packing 21, is attached to the clamping element 20. The clamping element 20 clamps the section 32 of the rotor blade 3 by pressing an upper surface 210 of the first packing 21 against the pressure side 33 of the rotor blade 3 and a lower surface 211 of the first packing 21 against the suction side 34 of the rotor blade 3 (see also FIG. 5). Thereby, the upper surface 210 and the lower surface 211 conformally adjoin the pressure side 33 and the suction side 34 of the rotor blade 3. Particularly, the lower surface 211 is flatter than the upper surface 210. The clamping element 20 is received in the tip transport frame 23 and connected thereto.

The tip transport frame 23 defines the height at which the section 32 of the rotor blade 3 is held.

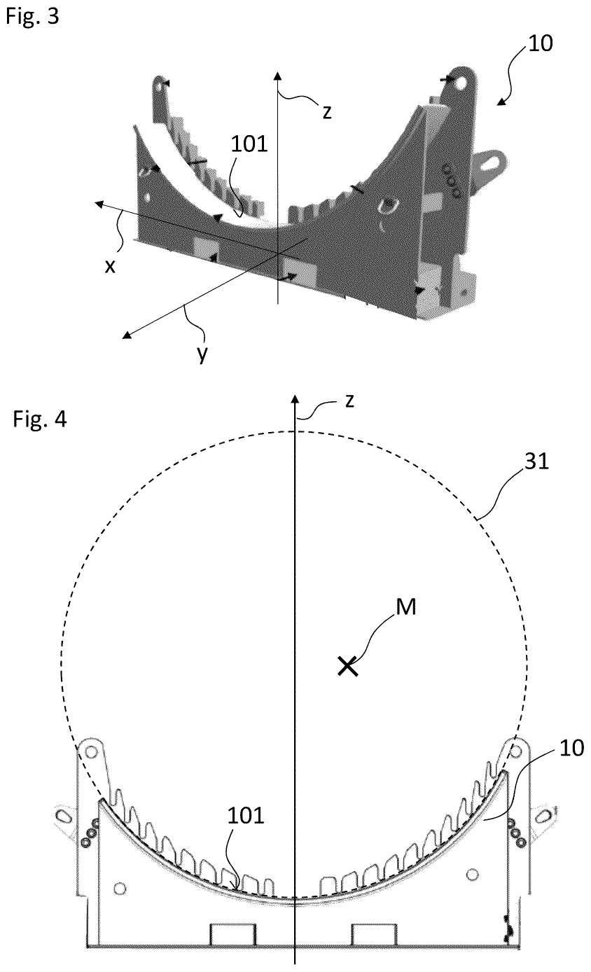

FIG. 3 shows the first root support element 10 in greater detail. As can be seen here, the root support element 10 includes a support surface 101 which is concavely shaped in order to reshape the root end of the rotor blade.

FIG. 4 shows the root support element 10 together with the root end 31 of the rotor blade 3 laid down on the support surface 101. FIG. 4 illustrates a view along the main extension direction (longitudinal axis) of the rotor blade 3. As can be seen here, the support surface 101 is actually asymmetric with respect to a vertical axis z that runs through the deepest point of the support surface 101. The section of the support surface 101 on the left side of the vertical axis is shorter than the section of the support surface 101 on the right side of the vertical axis. At the right side, that is, the side with longer section, the support surface 101 reaches a greater height than on the left side, that is, the side with the shorter section.

As can be further seen in FIG. 4, the center of gravity M of the rotor blade 3, indicated by the cross, is arranged on the same side as the longer section of the support surface 101, that is, also on the right side of the vertical axis. Particularly due to this asymmetric shape of the support surface 101, a secure support of the rotor blade 3 is enabled.

FIG. 5 shows the tip support structure of FIG. 2 in greater detail. Particularly, the upper 210 and the lower 211 surfaces of the first packing 21 are shown here in greater detail.

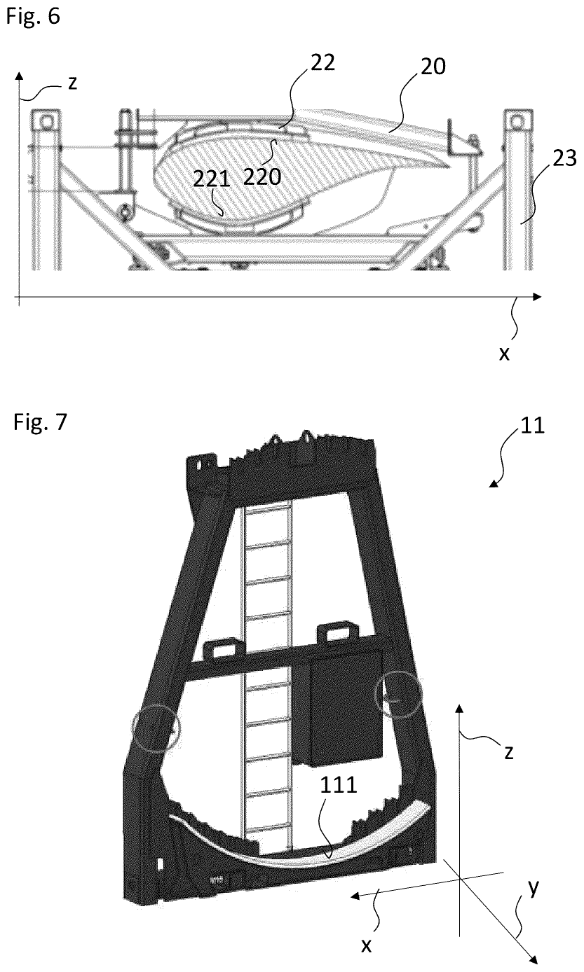

The first root support element 10, the clamping element 20, the first packing 21 and the tip transport frame 23 of FIGS. 2 to 5 constitute components of the transport system. Optionally, this transport system may include further components as described in connection with FIGS. 6 and 7. The further components described in connection with FIGS. 6 and 7 may be used in order to transport the rotor blade 3 with the pressure side down, for example, for sea transport.

As shown in FIG. 6, one optional component of the transport system is a further packing 22, herein also called second packing 22. The second packing 22 includes an upper surface 220 and a lower surface 221. Now the upper surface 220 is flatter than the lower surface 221, since the upper surface 220 reshapes the suction side 34 and the lower surface reshapes the pressure side 33. The second packing 22 can be used instead of the first packing 21 in the case that the transport is to be carried out with the pressure side down 33. The upper surface 220 and the lower surface 221 are pressed against the rotor blade 3 with the help of the same clamping element 20 as described in connection with the previous figures. However, the clamping element 20 has been rotated by 180° around a vertical axis with respect to the tip transport frame 23. The tip transport frame 23 is also the same as described in connection with the previous figures. That is, only the packing has to be replaced when changing from transport with the pressure side up to transport with a pressure side down or vice versa. The other components 20 and 23 of the tip support structure remain the same.

FIG. 7 shows a further root support element 11, herein also called second root support element 11, which is used instead of the first root support element 10 if the transport with the pressure side down is chosen. Also the second root transport element 11 includes a support surface 111. The support surface 111 is also formed concavely in order to formfittingly adjoin the root end of the rotor blade. Furthermore, the support surface 111 of the second root support element 11 is also asymmetric so that the section of the support surface 111 on one side of the deepest point of the support surface 111 is shorter than on the other side of the deepest point. However, as illustrated with the help of the consistently used coordinate system shown in the figures, the relative arrangement between the longer and the shorter section of the support surface 111 is inverse to the relative arrangement between the longer and the shorter section of the support surface 101 of the first root support element 10. This is because, by rotating the rotor blade 3 around its longitudinal axis in order to change from pressure side up to pressure side down, the center of gravity of the rotor blade is also rotated by 180°. To account for this, the location of the longer section of the support surface is changed.

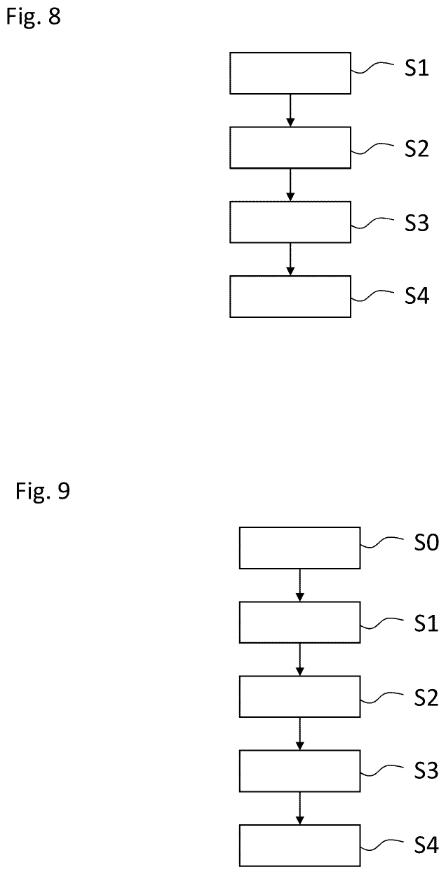

FIG. 8 shows a flowchart of an embodiment of the method for building a transport arrangement. This embodiment relates, for example, to the case that the previously described transport system only includes the components enabling the transport with the pressure side up, that is, it does not include the second root support element 11 (see FIG. 7) or the second packing 22 (see FIG. 6). In this case, the method includes a step S1 in which the transport system is provided, a step S2 in which the rotor blade is provided, a step S3 in which the root end of the rotor blade being orientated with its pressure side up is connected to the root support element and a step S4 in which the section of the rotor blade being orientated with its pressure side up is clamped into the clamping element.

FIG. 9 shows a flowchart of a further embodiment of the method for building a transport arrangement. This embodiment relates to the case that the transport system also includes components enabling transport with the pressure side down, that is, the transportation system also includes the second root support element 11 (see FIG. 7) and the second packing 22 (see FIG. 2). In this case, the method includes a step SO in which it is decided whether the rotor blade shall be transported with the pressure side up or the pressure side down. In step S1, the transportation system is provided. In step S2, the rotor blade is provided. In step S3, the root end of the rotor blade is connected to the first root support element 10 or the second root support element 11, depending on the decision of step S0. In step S4, the section of the rotor blade is clamped in the clamping element. Depending on the decision of step SO, the orientation of the clamping element with respect to the tip transport frame and the packing is chosen.

It is understood that the foregoing description is that of the preferred embodiments of the invention and that various changes and modifications may be made thereto without departing from the spirit and scope of the invention as defined in the appended claims.

### Reference Sign List

3 rotor blade
10 (first) root support element
11 further/second root support element
20 clamping element
21 (first) packing
22 further/second packing
23 tip transport frame
31 root end of the rotor blade
32 section of the rotor blade
33 pressure side of the rotor blade
34 suction side of the rotor blade
101 support surface
111 support surface
200 transport arrangement
210 upper surface
211 lower surface
220 upper surface
221 lower surface
1000 vehicle
x, y, z coordinates
M center of gravity
S0 to S4 method steps

1-14. (canceled)

15. A transport system comprising:
a root support element configured to be connected to a root end of a rotor blade;
a clamping element configured to clamp a section of the rotor blade distant from the root end; and,
the transport system being configured to enable a transport of the rotor blade for a wind turbine with a pressure side up when the root end of the rotor blade is connected to said root support element and when a section of the rotor blade is clamped in said clamping element.

16. The transport system of claim 15, wherein the transport system is additionally configured to enable the transport of the rotor blade with the pressure side down.

17. The transport system of claim 16, wherein:
said clamping element is configured to be used in two different orientations;
said two different orientations include a first orientation for the transport of the rotor blade with the pressure side up;
said two different orientations include a second orientation for the transport of the rotor blade with the pressure side down; and,
the clamping element is rotated around a vertical axis in the second orientation compared to the first orientation so that, when the transport system is used for transporting the rotor blade with the pressure side up, a side of said clamping element faces towards the root end of the rotor blade, and, when the transport system is used for transporting the rotor blade with the pressure side down, said side of said clamping element faces away from the root end of the rotor blade.

18. The transport system of claim 16 further comprising:
a packing having an upper surface and a lower surface, wherein said upper surface is configured to adjoin the pressure side of the rotor blade and said lower surface is configured to adjoin a suction side of the rotor blade;
a further packing having an upper further packing surface and a lower further packing surface, wherein said upper further packing surface is configured to adjoin the suction side of the rotor blade and said lower further packing surface is configured to adjoin the pressure side of the rotor blade;
said packing and said further packing both being reversibly attachable to said clamping element so that, depending on whether the rotor blade is to be transported with the pressure side up or down, either said packing or said further packing can be used for the transportation.

19. The transport system of claim 16 further comprising:
a further root support element; and,
the transport system enabling the transport of the rotor blade with the pressure side down when the root end of the rotor blade is connected to said further root support element and when the section of the rotor blade is clamped in said clamping element.

20. The transport system of claim 19, wherein:
said root support element has a first support surface and said further root support element has a second support surface, wherein said first support surface and said second support surface are configured to adjoin and support the root end of the rotor blade;
said first support surface and said second support surface are both concavely formed;
said first support surface has a first deepest point and is asymmetric with respect to said first deepest point such that a first longer section is defined on a first side of said first deepest point and a first shorter section is defined on a second side of said first deepest point;
said second support surface has a second deepest point and is asymmetric with respect to said second deepest point such that a second longer section is defined on a first side of said second deepest point and a second shorter section is defined on a second side of said second deepest point; and,
a first relative arrangement of said first longer section and said first shorter section of said first support surface of said root support element is inverse to a second relative arrangement of said second longer section and said second shorter section of said second support surface of said further root support element.

21. The transport system of claim 15 further comprising a tip transport frame configured to receive said clamping element and to be connected with said clamping element.

22. The transport system of claim of claim 17 further comprising:
a tip transport frame configured to receive said clamping element and to be connected with said clamping element;
wherein at least one of:
said clamping element being rotated relative to said tip transport frame around a vertical axis in said second orientation compared to said first orientation, and,
a relative orientation between said tip transport frame and said root support element during transport of the rotor blade with the pressure side up is the same as during transport of the rotor blade with the pressure side down.

23. A transport arrangement comprising:
a rotor blade having a root end;
a transport system having a root support element configured to be connected to a root end of a rotor blade;
said transport system further having a clamping element configured to clamp a section of said rotor blade distant from said root end;
said transport system being configured to enable a transport of said rotor blade for a wind turbine with a pressure side up when said root end of said rotor blade is connected to said root support element and when a section of said rotor blade is clamped in said clamping element;
said root end of said rotor blade is connected to said root support element and supported thereby;
said rotor blade has a section clamped in said clamping element; and,
said rotor blade is orientated with said pressure side up.

24. The transport arrangement of claim 23, wherein:
said transport system further includes a packing having an upper surface and a lower surface, wherein said upper surface is configured to adjoin said pressure side of said rotor blade and said lower surface is configured to adjoin a suction side of said rotor blade;
said transport system further include a further packing having an upper further packing surface and a lower further packing surface, wherein said upper further packing surface is configured to adjoin said suction side of said rotor blade and said lower further packing surface is configured to adjoin said pressure side of said rotor blade;
said packing and said further packing both being reversibly attachable to said clamping element so that, depending on whether said rotor blade is to be transported with the pressure side up, either said packing or said further packing can be used for the transportation;
said packing is attached to said clamping element; and,
said upper surface and said lower surface of said packing adjoin said rotor blade at said pressure side and at said suction side in a conformal manner.

25. The transport arrangement of claim 23, wherein:
said transport system is additionally configured to enable the transport of the rotor blade with the pressure side down;
said transport system further includes a packing having an upper surface and a lower surface, wherein said upper surface is configured to adjoin said pressure side of said rotor blade and said lower surface is configured to adjoin a suction side of said rotor blade;
said transport system further include a further packing having an upper further packing surface and a lower further packing surface, wherein said upper further packing surface is configured to adjoin said suction side of said rotor blade and said lower further packing surface is configured to adjoin said pressure side of said rotor blade;
said packing and said further packing both being reversibly attachable to said clamping element so that, depending on whether said rotor blade is to be transported with the pressure side up or down, either said packing or said further packing can be used for the transportation;
said packing is attached to said clamping element; and,
said upper surface and said lower surface of said packing adjoin said rotor blade at said pressure side and at said suction side in a conformal manner.

26. The transport arrangement of claim 23, wherein:
said root support element has a first support surface and said further root support element has a second support surface, wherein said first support surface and said second support surface are configured to adjoin and support the root end of the rotor blade;
said first support surface and said second support surface are both concavely formed;
said first support surface has a first deepest point and is asymmetric with respect to said first deepest point such that a first longer section is defined on a first side of said first deepest point and a first shorter section is defined on a second side of said first deepest point;
said second support surface has a second deepest point and is asymmetric with respect to said second deepest point such that a second longer section is defined on a first side of said second deepest point and a second shorter section is defined on a second side of said second deepest point; and,
a first relative arrangement of said first longer section and said first shorter section of said first support surface of said root support element is inverse to a second relative arrangement of said second longer section and said second shorter section of said second support surface of said further root support element;
said root end of said rotor blade adjoins said first support surface of said root support element and is supported thereby; and,
a center of gravity of said rotor blade is arranged on the same side as said first longer section of said first support surface.

27. A vehicle comprising the transport arrangement of claim 23, wherein the vehicle is configured to transport said rotor blade from one location to another location.

28. A method for building a transport arrangement including a rotor blade having a root end, the transport arrangement further having a transport system having a root support element configured to be connected to a root end of a rotor blade; the transport system further having a clamping element configured to clamp a section of the rotor blade distant from the root end; the transport system being configured to enable a transport of the rotor blade for a wind turbine with a pressure side up when the root end of the rotor blade is connected to the root support element and when a section of the rotor blade is clamped in the clamping element; the root end of the rotor blade being connected to the root support element and supported thereby; the rotor blade having a section clamped in the clamping element; and, the rotor blade being orientated with the pressure side up, the method comprising:
providing the transport system;
providing the rotor blade;
connecting the root end of the rotor blade being orientated with its pressure side up to the root support element; and,
clamping a section of the rotor blade being orientated with its pressure side up into the clamping element.
